(19) United States
(12) Patent Application Publication
(10) Pub. No.: US 2018/0252307 A1
(43) Pub. Date: Sep. 6, 2018

(54) APPARATUS FOR SEALING A ROTATING COMPONENT IN AN OIL SUMP

(71) Applicant: GM GLOBAL TECHNOLOGY OPERATIONS LLC, Detroit, MI (US)

(72) Inventors: Avinash Singh, Sterling Heights, MI (US); Mohammad A. Hotait, Rochester Hills, MI (US); Christopher B. Preston, Troy, MI (US)

(21) Appl. No.: 15/448,689

(22) Filed: Mar. 3, 2017

(51) Int. Cl. F16H 57/04

(52) U.S. Cl. CPC F16H 57/0454; F16H 57/0452

(57) ABSTRACT

An apparatus for sealing a portion of a rotating component within an oil sump environment including an at least two piece assembly having complementary peripheral joining edges for shielding a portion of the rotating component from the oil sump environment. A sealing material or device is disposed between the complementary peripheral joining edges of the at least two piece assembly for enhancing the prevention lubricant flow into the sealed environment.

### FIELD

Apparatuses consistent with exemplary embodiments relate to apparatuses for transmission lubrication systems. More particularly, apparatuses consistent with exemplary embodiments relate to an apparatus for sealing a gear in an oil sump.

### BACKGROUND

The statements in this section merely provide background information related to the present disclosure and may or may not constitute prior art.

As in all mechanical processes, reduced efficiency in gearboxes arise due to various power losses. During the transfer of power in the transmission, a substantial percentage of the total energy losses are due to the transmission pumping transmission fluid to the working components of the transmission, sometimes referred to as no-load losses.

No-load losses occur even without any load being transmitted. They are due to the rotation of shafts, which causes bearings and gears to be dragged in the lubricant. Energy losses when gears are dragged in the lubricant are called churning losses and are affected by the oil level, viscosity of the lubricant and rotational speed. Gear churning losses can be a major contributor to the total energy losses in a gearbox.

To mitigate the performance inefficiencies due to no-load losses, it would be desirable to create a sealed environment for gear(s)/component(s) rotating in, or proximate to, a lubricating oil sump.

### SUMMARY

One or more exemplary embodiments address the above issue by providing apparatuses for transmission lubrication systems. More particularly, apparatuses consistent with exemplary embodiments relate to an apparatus for sealing a rotating component in a lubricating oil sump.

According to an aspect of an exemplary embodiment, an apparatus for sealing a portion of a rotating component within a lubricating oil sump environment includes an at least two piece assembly having complementary peripheral joining edges for shielding a portion of the rotating component from the oil sump environment. And another aspect of the exemplary embodiment includes a sealer disposed between the at least two piece assembly for preventing fluid flow through the complementary peripheral joining edges unto the rotating component.

Yet another aspect of the exemplary embodiment wherein the at least two piece assembly includes a base piece attached to a transfer case housing and a crown piece attached to a transfer case housing cover. Still another aspect as according to the exemplary embodiment wherein the sealer is an oil ring.

In accordance with other aspects of the exemplary embodiment wherein the sealer is a foam gasket. In accordance with further aspects of the exemplary embodiment, wherein the sealer is a rubber gasket. Still in accordance with aspects of the exemplary embodiment, wherein the sealer is a compression gasket.

Yet another aspect of the exemplary embodiment, wherein the sealer is a liquid polyethylene composite sealant. Still another aspect of the exemplary embodiment includes at least one oil regulator valve. And another aspect of the exemplary embodiment wherein the at least two piece assembly covers greater than half of the rotating component. And another aspect wherein the at least two piece assembly covers the rotating component entirely below a static oil level in the oil sump.

### BRIEF DESCRIPTION OF THE DRAWINGS

The present exemplary embodiments will be better understood from the description as set forth hereinafter,with reference to the accompanying drawings, in which:

FIG. 1 is a schematic illustration of a powertrain for a FWD vehicle in accordance with an aspect of the exemplary embodiment;

FIG. 2 is an illustration of a FWD transmission transfer case including a final drive gear shielded with the sealing apparatus in accordance with aspects of an exemplary embodiment; and

FIG. 3 is an illustration of a cross-sectional view of the sealing apparatus in accordance with aspects of an exemplary embodiment.

### DETAILED DESCRIPTION OF THE INVENTION

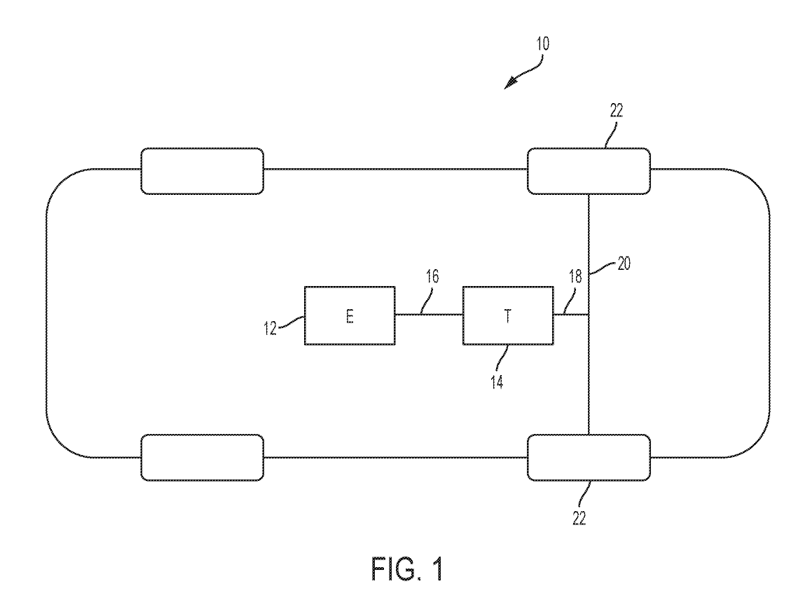

The following description is merely exemplary in nature and is not intended to limit the present disclosure, application, or uses thereof. FIG.1 provides an illustration of a powertrain 10 for a FWD vehicle in accordance with aspects of an exemplary embodiment. The powertrain 10 includes an engine 12, a transmission 14 having rotating components (e.g., FWD, RWD, automatic, continuously variable, hybrid, eAWD, dual clutch or manual), a driveshaft 16 and transmission output shaft 18, drive shaft 20 and front drive wheels 22. It is appreciated that the exemplary embodiment relates to a traditional vehicle propulsion systems but the inventive concept is also applicable to any other non-conventional and/or combined propulsion systems, including or equipment motors and machinery having rotating components subject to no load losses due to lubricant churning.

The engine 12 is an internal combustion engine that supplies a driving torque to the transmission 14. Traditionally, an internal combustion engine is identified by the number of cylinders it includes and in what configuration the cylinders are arranged however in this case not relevant to the scope of the exemplary embodiment. The transmission 14, capable of several forward gear ratios, in turn delivers torque to the output shaft 18, the drive shaft 20 and drive wheels 22.

It is appreciated that no-load gear losses mainly depend on the immersion depth of rotating gears in lubricant oil sumps, the speed of the rotating gears, as well as, the viscosity of the lubricant. Such losses demand more energy from the engine to actuate all of the parts rotating gears that come into contact with the lubricating fluid. Increased demand for energy from the engine requires increased need for fuel which could affect the vehicle's fuel economy.

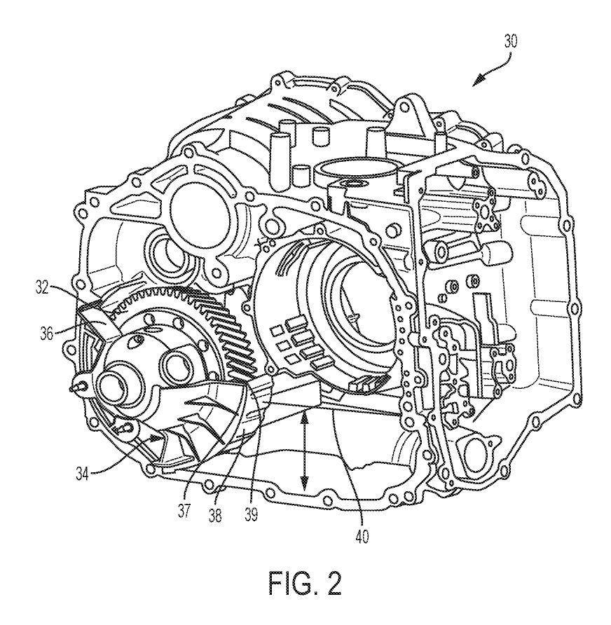

Referring now to FIG. 2, an illustration of a FWD transmission transfer case housing 30 including a final drive gear 32 disposed within the sealing apparatus 34 in accordance with the exemplary embodiment is provided. It is appreciated that the sealing apparatus 34 according to the exemplary embodiment may be used to create a sealed environment around any rotating component/gear in a lubricant fluid environment where it is desirable to shield such components from the splash/splatter of churning lubricants.

The transfer case housing 30 includes a transfer case housing cover (not shown) which attaches to the transfer case 30 to form an enclosure to protect the rotating components and contain lubricating fluid from the outside environment. It is appreciated that the exemplary embodiment is in reference to a FWD transmission system but the disclosed concept is applicable to other transmission systems (e.g. automatic, CVT, DCT, RWD, eAWD, or manual) in general which are intended to be within the disclosed concept.

The sealing apparatus 34 is formed of an at least two piece assembly having complementary peripheral joining edges for shielding a portion of the rotating component from the oil sump environment when the at least two piece assembly is joined together. In accordance with one embodiment, a crown piece 36 of the assembly is attached to the transfer case housing cover (not shown) and a base piece 38 of the assembly is attached to the transfer case housing 30.

To enhance the integrity of the seal of the at least two piece assembly, the crown piece 36 includes a complementary peripheral joining edge 37, and likewise, the base piece 38 includes a complementary peripheral joining edge 39 wherein the edges are configured to join together in a mechanically interlocking seal which is further strengthened by introducing a sealing material/device between the edges in accordance with the exemplary embodiment.

In one embodiment, the at least two piece assembly covers greater than half of the rotating component 32, while for another embodiment, the at least two piece assembly covers the entire rotating component 32 but includes at least one oil regulator valve to accurately control the amount of lubricating fluid that is disposed on the rotating component. In this manner, the amount of energy losses due to the rotating components being immersed and churning in lubricant fluids or being exposed to lubricant splash/splatter from other components can be effectively mitigated.

In one other embodiment, the at least two piece assembly covers the rotating component 32 entirely below a static oil level 40 in the lubricating oil sump. This configuration ensures that excessive churning is minimized for rotating components disposed in a wet sump environment.

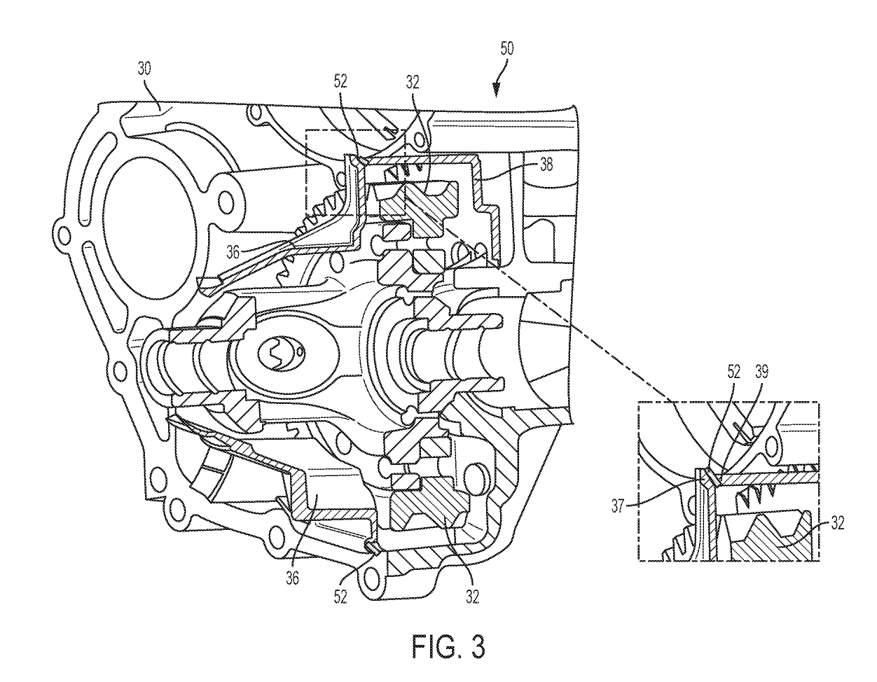

Referring now to FIG. 3, an illustration of a cross-sectional view 50 of the sealing apparatus 34 in accordance with aspects of an exemplary embodiment is provided. The sealing apparatus 34 includes a sealing material/device 52 disposed between the complementary peripheral joining edges (37, 39) of the crown piece 36 and base piece 38 of the two piece assembly, respectively. The sealing material/device may be in the form of an oil ring, a foam gasket, a rubber gasket, a compression gasket, liquid polyethylene composite sealant, and/or any other device or materials suitable for the intended purpose.

The description of the invention is merely exemplary in nature and variations that do not depart from the gist of the invention are intended to be within the scope of the invention. Such variations are not to be regarded as a departure from the spirit and scope of the invention.

What is claimed is:

1. An apparatus for sealing a portion of a rotating component within an oil sump environment comprising:
an at least two piece assembly having complementary peripheral joining edges for shielding a portion of the rotating component from the oil sump environment; and
a sealer disposed between the at least two piece assembly for preventing fluid flow through the complementary peripheral joining edges.

2. The apparatus of claim 1 wherein the at least two piece assembly includes a base piece attached to a transfer case housing and a crown piece attached to a transfer case housing cover.

3. The apparatus of claim 1 wherein the sealer is an oil ring.

4. The apparatus of claim 1 wherein the sealer is a foam gasket.

5. The apparatus of claim 1 wherein the sealer is a rubber gasket.

6. The apparatus of claim 1 wherein the sealer is a compression gasket.

7. The apparatus of claim 1 wherein the sealer is a liquid polyethylene composite sealant.

8. The apparatus of claim 1 further comprising at least one oil regulator valve.

9. The apparatus of claim 1 wherein the at least two piece assembly covers greater than half of the rotating component.

10. The apparatus of claim 9 wherein the at least two piece assembly covers the rotating component entirely below a static oil level in the oil sump.
